(19) United States
(12) Patent Application Publication
(10) Pub. No.: US 2022/0203894 A1
(43) Pub. Date: Jun. 30, 2022

(54) VEHICLE SVM SYSTEM INCLUDING TILT CAMERA

(71) Applicant: SAMSUNG ELECTRO-MECHANICS CO., LTD., Suwon-si (KR)

(72) Inventors: Dong Chang HONG, Suwon-si (KR); Young Ki LEE, Suwon-si (KR); Doo Hyung KWON, Suwon-si (KR)

(73) Assignee: SAMSUNG ELECTRO-MECHANICS CO., LTD., Suwon-si (KR)

(21) Appl. No.: 17/407,798

(22) Filed: Aug. 20, 2021

(30) Foreign Application Priority Data
Dec. 28, 2020 (KR) 10-2020-0185031

(51) Int. Cl. B60R 1/00; B60R 11/04; H04N 5/225

(52) U.S. Cl. CPC B60R 1/002; B60R 11/04; H04N 5/2257; B60R 2300/20; H04N 5/2254; B60R 2300/101; H04N 5/2253

(57) ABSTRACT

A vehicle surround viewing monitor (SVM) system includes: a tilt camera device including camera modules configured to image a surround view of a vehicle; and a control device configured to generate a control signal for adjusting a detection angle of the tilt camera device according to an operating mode of the vehicle, based on received vehicle information. The tilt camera device is configured to adjust a detection angle of each of the camera modules, in response to the control signal.

### CROSS-REFERENCE TO RELATED APPLICATION(S)

This application claims the benefit under 35 U.S.C. § 119(a) of Korean Patent Application No. 10-2020-0185031 filed on Dec. 28, 2020 in the Korean Intellectual Property Office, the entire disclosure of which is incorporated herein by reference for all purposes.

### BACKGROUND

### 1. Field

The following description relates to a surround viewing monitor (SVM) system of a vehicle including a tilt camera that can be applied to an autonomous vehicle.

### 2. Description of Related Art

In general, a surround viewing monitor (SVM) for parking assistance convenience to a driver may be mounted on a vehicle.

In general, a SVM system is a system assisting driving by synthesizing four images in front, rear, left, and right directions of a vehicle using four wide-angle (180° to 195°) cameras, and providing the synthesized four images to a driver by displaying the synthesized four images on a screen.

This existing SVM system is designed to perform fixed viewing or fixed detection of a nearby lane, or a close-up viewing of less than a certain distance (e.g., 6M) due to a parking assist function.

Accordingly, in the SVM system, since a detection view is fixed, there is a problem in that a view seen by the driver is changed according to a vehicle operating mode such as a driving mode or a parking mode.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicle surround viewing monitor (SVM) system includes: a tilt camera device including camera modules configured to image a surround view of a vehicle; and a control device configured to generate a control signal for adjusting a detection angle of the tilt camera device according to an operating mode of the vehicle, based on received vehicle information. The tilt camera device is configured to adjust a detection angle of each of the camera modules, in response to the control signal.

In a parking mode, the tilt camera device may be configured to adjust the detection angle of each of the camera modules to a predetermined detection angle for parking, based on the control signal. In a driving mode, the tilt camera device may be further configured to adjust the detection angle of each of the camera modules to a detection angle for driving that is increased by a preset angle from the predetermined detection angle for parking, based on the control signal.

The control device may include: an operating mode recognition unit configured to recognize the operating mode of the vehicle as either one of a driving mode and a parking mode, based on vehicle speed information and gear information included in the vehicle information; and a control signal generation unit configured to generate the control signal to adjust the detection angle of the tilt camera device to a detection angle corresponding to the recognized operating mode.

The control device may be further configured to generate either one of a driving mode control signal and a parking mode control signal as the detection angle control signal, to control the tilt camera device, to adjust the detection angle of the tilt camera device.

The control device may be further configured to compensate for the detection angle of the tilt camera device in the recognized operating mode, based on steering angle information included in the vehicle information, and generate the control signal for controlling one or more of the camera modules with the compensated detection angle.

Each of the camera modules may include a voice coil motor actuator configured to adjust the detection angle of the corresponding camera module in response to the control signal.

Each of the camera modules may include: an outer case; driving coil units disposed on the outer case, and configured to generate electromagnetic force; a lens unit configured to receive a video image in a corresponding imaging direction for a surround view of the vehicle; a sensor substrate unit including an image sensor configured to sense a video image through the lens unit, and disposed to be movable through a ball with respect to the outer case; and driving conductor units disposed on the sensor substrate unit, and configured to be moved by the electromagnetic force generated by a corresponding driving coil unit among the driving coil units, to adjust a detection angle of the lens unit.

The vehicle SVM system may further include: an interface unit configured to receive the vehicle information and output the vehicle information to the control device; and a display unit configured to output at least one of images acquired by the tilt camera device, according to the control device, to a screen.

In another general aspect, a vehicle surround viewing monitor (SVM) system includes: a tilt camera device including a first camera module, a second camera module, a third camera module, and a fourth camera module that are configured to image a surround view of a vehicle; an interface unit configured to receive vehicle information including vehicle speed information and gear information; and a control device configured to generate a control signal for adjusting an imaging direction of the tilt camera device according to an operating mode of the vehicle, based on the vehicle information. The tilt camera device may be configured to adjust a detection angle of each of the camera modules, in response to the control signal.

In a parking mode, the tilt camera device may be configured to adjust a detection angle of each of the first, second, third, and fourth camera modules to a predetermined detection angle for parking, based on the control signal. In a driving mode, the tilt camera device may be further configured to adjust a detection angle of each of the first, second, third, and fourth camera modules to a detection angle for driving that is increased by a preset angle from the detection angle for parking, based on the control signal.

The control device may include: an operating mode recognition unit configured to recognize the operating mode of the vehicle as either one of a driving mode and a parking mode, based on vehicle speed information and gear information included in the vehicle information; and a control signal generation unit configured to generate the control signal to adjust the detection angle of the tilt camera device to a detection angle corresponding to the recognized operating mode.

The control device may be further configured to generate either one of a driving mode control signal and a parking mode control signal to control the tilt camera device, to adjust the detection angle of the tilt camera device.

The control device may be further configured to compensate for the detection angle of the tilt camera device in the recognized corresponding operating mode, based on steering angle information included in the vehicle information, and generate the control signal for controlling one or more of the camera modules with the compensated detection angle.

Each of the first, second, third, and fourth camera modules may include a voice coil motor actuator configured to adjust the detection angle of the corresponding camera module in response to the control signal.

Each of the camera modules may include: an outer case; driving coil units disposed on the outer case, and configured to generate electromagnetic force; a lens unit configured to receive a video image in a corresponding imaging direction for a surround view of the vehicle; a sensor substrate unit including an image sensor configured to sense a video image through the lens unit, and disposed to be movable through a ball with respect to the outer case; and driving conductor units disposed on the sensor substrate unit, and configured to be moved by the electromagnetic force generated by a corresponding driving coil unit among the driving coil units, to adjust a detection angle of the lens unit.

The vehicle SVM system may further include a display unit configured to output at least one of images acquired by the tilt camera device, according to the control device, to a screen.

In another general aspect, a method of providing a surround view of a vehicle includes: recognizing an operating mode of the vehicle based on received vehicle information; generating a control signal for a tilt camera device of the vehicle, according to the recognized operating mode; and adjusting a detection angle of each of camera modules of the tilt camera device, in response to the control signal, wherein the camera modules are configured to image a surround view of a vehicle.

The recognizing of the operating mode may include: recognizing the operating mode as a parking mode, in response to the vehicle being driven at a speed less than a threshold speed or being driven in reverse; or recognizing the operating mode as a driving mode, in response to the vehicle being driven at a speed greater than the threshold speed.

The adjusting of the detection angle of each of the camera modules may include adjusting the detection angle of each of the camera modules to a respective preset detection angle corresponding to the control signal.

The camera modules may include: a front camera module disposed at a front side of a vehicle; a rear camera module disposed at a rear side of the vehicle; and side camera modules respectively disposed at a left and right sides of the vehicle.

In another general aspect, a non-transitory computer-readable storage medium stores instructions that, when executed by a processor, cause the processor to perform the method described above.

Other features and aspects will be apparent from the following detailed description, the drawings, and the claims.

### BRIEF DESCRIPTION OF DRAWINGS

FIG. 1 is a diagram of a vehicle surround viewing monitor (SVM) system of a vehicle, according to an embodiment.

FIG. 2 is a diagram of a vehicle SVM system of a vehicle, according to another embodiment.

FIG. 3 is a diagram of a control device, according to an embodiment.

FIG. 4 is a diagram of a camera module, according to an embodiment.

FIG. 5 is a diagram of a vehicle SVM system, according to another embodiment.

FIGS. 6A to 6D are diagrams illustrating installation of a first camera module, a second camera module, a third camera module, and a fourth camera module, according to an embodiment.

FIG. 7 is a diagram illustrating a parking mode detection angle and a driving mode detection angle of the first camera module, according to an embodiment.

FIG. 8 is a diagram illustrating a parking mode detection angle and a driving mode detection angle of the second camera module, according to an embodiment.

FIG. 9 is a diagram illustrating a parking mode detection angle and a driving mode detection angle of the third camera module or the fourth camera module, according to an embodiment.

FIG. 10 is a view of a parking mode detection angle and a driving mode detection angle of the third camera module and the fourth camera module, according to an embodiment.

FIG. 11 is a diagram of a parking mode detection region of an SVM system of a vehicle, according to an embodiment.

FIG. 12 is a diagram of a driving mode detection region of an SVM system of a vehicle, according to an embodiment.

Throughout the drawings and the detailed description, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Herein, it is to be noted that use of the term “may” with respect to an embodiment or example, e.g., as to what an embodiment or example may include or implement, means that at least one embodiment or example exists in which such a feature is included or implemented while all examples and examples are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape occurring during manufacturing.

The features of the examples described herein may be combined in various ways as will be apparent after an understanding of this disclosure. Further, although the examples described herein have a variety of configurations, other configurations are possible as will be apparent after an understanding of this disclosure.

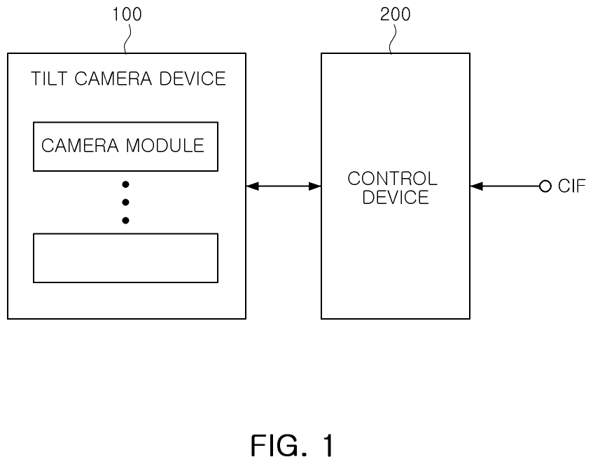

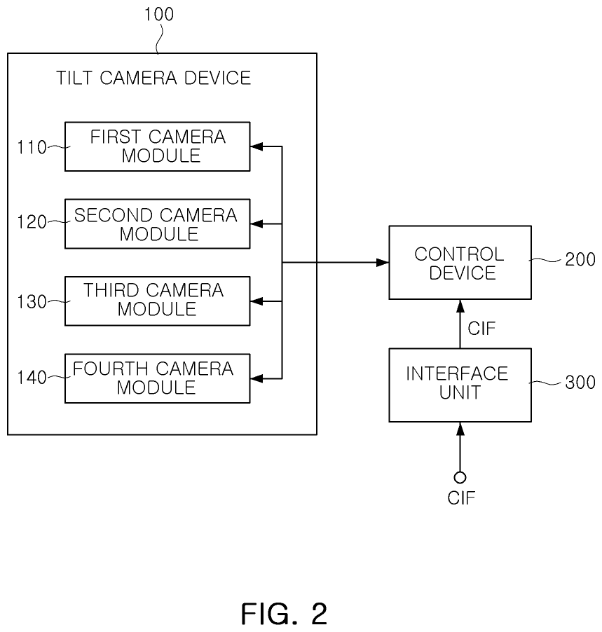

FIG. 1 is a diagram of a vehicle surround viewing monitor (SVM) system, according to an embodiment. FIG. 2 is a of a vehicle SVM system, according to another embodiment.

Referring to FIGS. 1 and 2, a vehicle SVM system may include a tilt camera device 100 and a control device 200.

The tilt camera device 100 may include, for example, a plurality of camera modules 110, 120, 130, and 140 having an adjustable detection angle, and configured to image a surround view of a vehicle.

The control device 200 may generate a corresponding control signal SC for adjusting the detection angle of the tilt camera device 100 according to an operating mode of a vehicle, based on received vehicle information CIF, to control the tilt camera device 100 using the control signal SC.

Referring to FIG. 2, a vehicle SVM system may include the camera device 100, an interface unit 300, and the control device 200.

For example, the camera device 100 may include the first camera module 110, the second camera module 120, the third camera module 130, and the fourth camera module 140, but is not limited to including first, second, third, and fourth camera modules 110, 120, 130, and 140.

For example, the first camera module 110 may be installed to detect a front side of the vehicle, the second camera module 120 may be installed to detect a rear side of the vehicle, the third camera module 130 may be installed to detect a left side of the vehicle, and the fourth camera module 140 may be installed to detect a right side of the vehicle.

The interface unit 300 may receive the vehicle information CIF, and provide the vehicle information CIF to the control device 200. For example, the vehicle information CIF may include vehicle speed information VI, gear information GI, and steering angle information GAI. The vehicle speed information VI may be provided from a speed sensor mounted on the vehicle. The gear information GI may be provided from a gear device of the vehicle. The steering angle information GAI may be provided from a steering device of the vehicle.

The control device 200 may generate a corresponding control signal SC for adjusting a detection direction (or an imaging direction) of the tilt camera device 100 according to an operating mode of the vehicle, based on the vehicle information CIF input through the interface unit 300.

Referring to FIGS. 1 and 2, the tilt camera device 100 may adjust a detection angle (or a shooting angle) of each of the plurality of camera modules 110, 120, 130, and 140 in response to the control signal SC of the control device 200.

For example, the tilt camera device 100 may adjust the detection angle of each of the first camera module 110, the second camera module 120, the third camera module 130, and the fourth camera module 140.

For example, based on the control signal SC of the control device 200, in a parking mode, the tilt camera device 100 may adjust the detection angle of each of the first camera module 110, the second camera module 120, the third camera module 130, and the fourth camera module 140 to a predetermined detection angle for parking.

For example, in the parking mode, the detection angles of the first camera module 110, the second camera module 120, the third camera module 130, and the fourth camera module 140 may be 33 degrees, 45 degrees, 15 degrees, and 26 degrees, respectively, in the corresponding direction with respect to a vertical direction to a ground. However, the detection angles provided for the parking mode are merely examples, and the disclosure is not limited to these examples.

In addition, based on the control signal SC of the control device 200, in a driving mode, the tilt camera device 100 may adjust the detection angle of each of the first camera module 110, the second camera module 120, the third camera module 130, and the fourth camera module 140 to a detection angle that is increased by a preset angle (e.g., 6 degrees) from the detection angle for parking.

For example, in the driving mode, the detection angles of the first camera module 110, the second camera module 120, the third camera module 130, and the fourth camera module 140 may be 39 degrees, 51 degrees, 21 degrees, and 32 degrees, respectively, which are 6 degrees higher than the corresponding detection angles for parking, with respect to a vertical direction to a ground. However, the detection angles provided for the driving mode are merely examples, and the disclosure is not limited to these examples.

For each drawing of this disclosure, unnecessary redundant descriptions of the same reference numerals and components having the same function may be omitted, and possible differences may be described for each drawing.

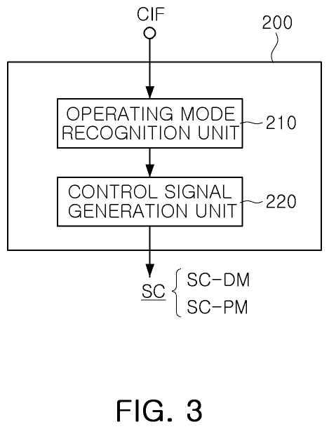

FIG. 3 is a diagram of the control device 200, according to an embodiment.

Referring to FIG. 3, the control device 200 may include, for example an operating mode recognition unit (operating mode recognizer) 210 and a control signal generation unit (or control signal generator) 220.

The operating mode recognition unit 210 may recognize an operating mode of the vehicle as a driving mode (DM) or a parking mode (PM), based on vehicle speed information (VI) and the gear information (GI) included in the vehicle information (CIF).

For example, the driving mode (DM) may correspond to forward driving of the vehicle of 30 km/h or more, and the parking mode (PM) may correspond to driving of the vehicle, including forward and reverse driving, of 30 km/h or less. However, the foregoing description of the driving mode (DM) and the parking mode (PM) is merely an example, and the disclosure is not limited to the described example.

In addition, when a gear position is in a trailing state (e.g., “reverse state,” or an R condition) or in a low-speed state (e.g., 30 km/h or less), the vehicle can be operated under an SVM's original parking assistance system or parking mode condition. On the other hand, when a driver is in a driving mode exceeding 30 Km/h of vehicle speed or artificially requests an enable condition, the SVM camera mounted on the vehicle may be changed automatically so that a central axis of a field of view is changed from a bottom to a top by a predetermined angle using a tilt function, and a camera logic may perform a sensing function.

That is, when a gear position is in a trailing condition (e.g., reverse or ‘R’ stage) or in a low-speed (<30 km/h) condition, the vehicle's SVM system acquires image information of an object using a tilt camera device, and performs a driver parking assistance function such as a birds-eye view, a moving object detection (MOD), a 3D view, and the like using each of the four object image information.

The control signal generator 220 may generate the control signal SC for adjusting the tilt camera device 100 to a detection angle corresponding to the operating mode recognized by the operating mode recognition unit 210.

For example, the control device 200 may generate a driving mode control signal (SC-DM) or a parking mode control signal (SC-PM) to adjust the detection angle of the tilt camera device 100 to control the tilt camera device 100.

In addition, the control device 200 may compensate for a detection angle in the recognized corresponding operating mode, based on the steering angle information GAI included in the vehicle information CIF, and generate a control signal for controlling the corresponding camera module with the compensated detection angle, to control the corresponding camera module of the tilt camera device.

For example, when there is a change in steering angle information GAI, the operating mode recognition unit 210 may provide the steering angle information GAI to a control signal generation unit 220. The control signal generation unit 220 may further adjust the detection angle of the front or rear camera module, based on the steering angle information (GAI) provided from the operating mode recognition unit 210.

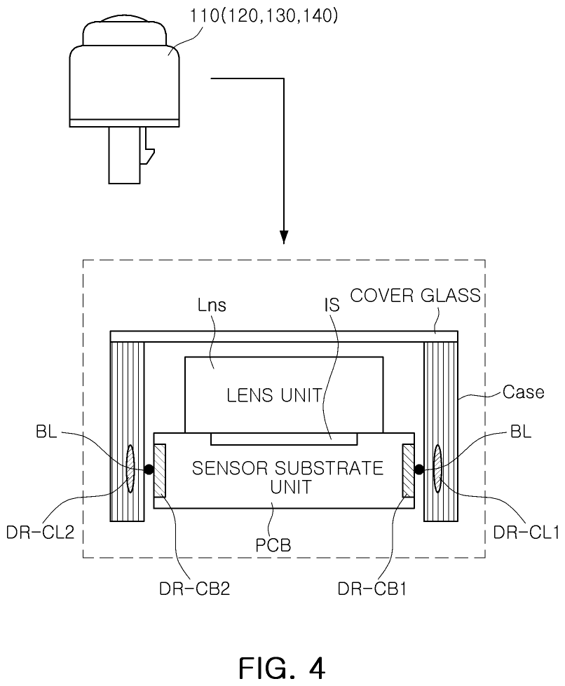

Each of the camera modules 110, 120, 130, and 140 may include a voice coil motor (VCM) actuator configured to adjust the detection angle in response to the control signal SC of the control device 200. The adjusting of the detection angle in response to the control signal will be described in more detail with reference to FIG. 4.

FIG. 4 is a diagram of each of the camera modules 110, 120, 130, and 140, according to an embodiment.

Referring to FIG. 4, each of the plurality of camera modules 110, 120, 130, and 140 may include an outer case and a cover glass, a plurality of driving coil units DR-CL1 and DR-CL2, a lens unit Lns, a sensor substrate unit PCB, and a plurality of driving conductor units DR-CB1 and DR-CB2.

The outer case may be a case surrounding the camera module, and the cover glass may be a glass member allowing light to enter the lens unit Lns.

The plurality of driving coil units DR-CL1 and DR-CL2 may be disposed on the outer case to generate electromagnetic force to adjust the detection angle. For example, although the two driving coil units DR-CL1 and DR-CL1 are illustrated in FIG. 4, the disclosure is not limited to this configuration, and four driving coil units may be provided, such that one driving coil unit is provided for each tilt direction.

The lens unit Lns may receive a video image in a corresponding imaging direction for a surround view of the vehicle. For example, the lens unit Lns may sense one of a front image, a rear image, a left image, and a right image.

The sensor substrate unit PCB may include an image sensor IS for sensing a video image through the lens unit Lns, and may be disposed to be movable through a ball BL with respect to the outer case.

The plurality of driving conductor units DR-CB1 and DR-CB2 may be disposed on the sensor board unit PCB to face the plurality of driving coil units DR-CL1 and DR-CL2, and be moved by electromagnetic force by the plurality of driving coil units DR-CL1 and DR-CL2, to adjust the detection angle of the lens unit Lns.

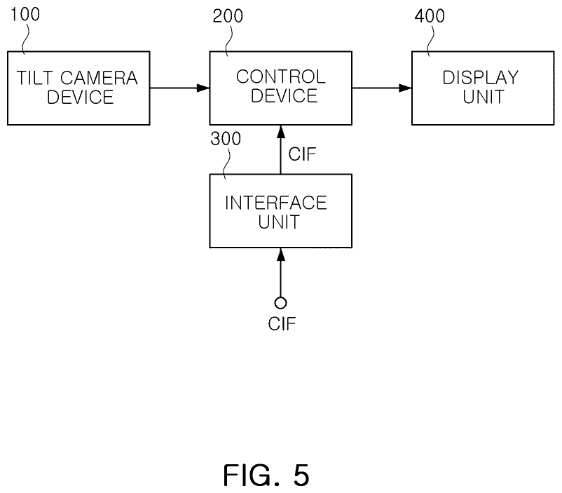

FIG. 5 is another diagram of a vehicle's SVM, according to an embodiment.

Referring to FIG. 5, a vehicle SVM system may include the tilt camera device 100, the control device 200, the interface unit 300, and a display unit 400.

The tilt camera device 100, the control device 200, and the interface unit 300 are the same as those described with reference to FIGS. 1 to 3, and thus, further descriptions thereof will be omitted.

The display unit 400 may output at least one of images acquired by the tilt camera device 100 according to the control device 200 to a screen.

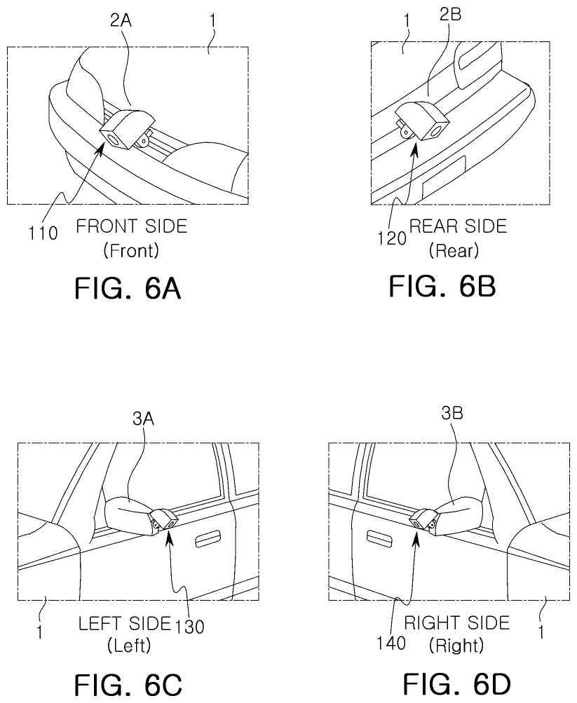

FIGS. 6A to 6D are views illustrating installation of the first camera module 110, the second camera module 120, the third camera module 130, and the fourth camera module 140.

Referring to FIG. 6A, the first camera module 110 may be installed on a front surface 2A (e.g., a radiator grill) of a vehicle 1. Referring to FIG. 6B, the second camera module 120 may be installed on a rear surface 2B (e.g., a trunk portion) of the vehicle 1. Referring to FIG. 6C, the third camera module 130 may be installed on a left side 3A of the vehicle 1 (e.g., a left outside mirror portion). Referring to FIG. 6D, the fourth camera module 140 may be installed on a right side 3B (e.g., a right outside mirror portion) of the vehicle 1.

FIGS. 6A to 6D include examples showing locations (e.g., front, rear, left, right, and the like) of the vehicle 1 in which the first camera module 110, the second camera module 120, the third camera module 130, and the fourth camera module 140 are installed, and it does not limit a form, size, or the like of the first to forth camera modules 110 to 140.

In addition, the control device 200 (e.g., ECU) of the vehicle SVM system may provide parking convenience by showing one screen in birds-eye view to a driver through the display unit 400 by stitching images input to the four first to fourth camera modules 110 to 140.

In addition, in the disclosed vehicle SVM system, which uses the four first to fourth camera modules 110 to 140, unlike the conventional short-distance low-speed parking assistance system for assisting a driver, a higher-performance advanced driver assistant system (ADAS) can be additionally established by automatically changing a camera's central field of view according to an operating mode using an automatic tilt function to perform a function of sensing, rather than simple viewing.

As shown in FIG. 4, a tilt actuator is built into the camera module 110 (120, 130, 140), and one part of the board (PCB) is deflected using a current control method, such that an angle of the camera module 110 (120, 130, 140) may be adjusted, as a means of changing a tilt direction. For example, the driving coil unit DR-CL1, DR-CL2 for controlling a current and the driving conductor unit DR-CB1, DR-CB2 moved by electromagnetic force of the driving coil unit driving coil unit DR-CL1, DR-CL2 may be built into each of the camera modules 110, 120, 130, and 140 to perform the tilt function.

When a gear position is driving (a stage ‘D’) or in a driving mode (e.g., forward at >30 Km/h) condition, the tilt camera device 100 may be tilted to an optimal central angle of view for performing a sensing function, acquire image information of an object, and perform functions of a lane change, a blind spot detection, a front cross traffic alert (CTA), a wide rearview vision (panoramic view), and the like using each of four object image information from the first to fourth camera modules 110 to 140, respectively.

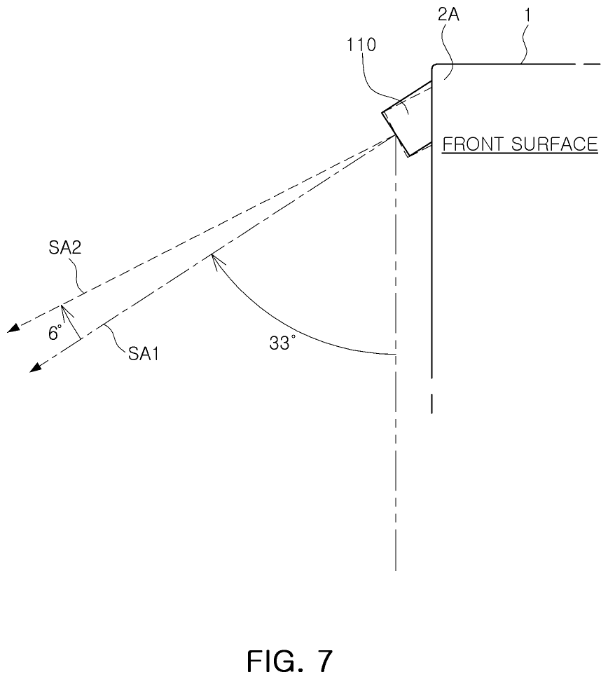

The tilt of the corresponding camera module 110, 120, 130, 140 in the driving mode as described above will be described with reference to FIGS. 7 to 10.

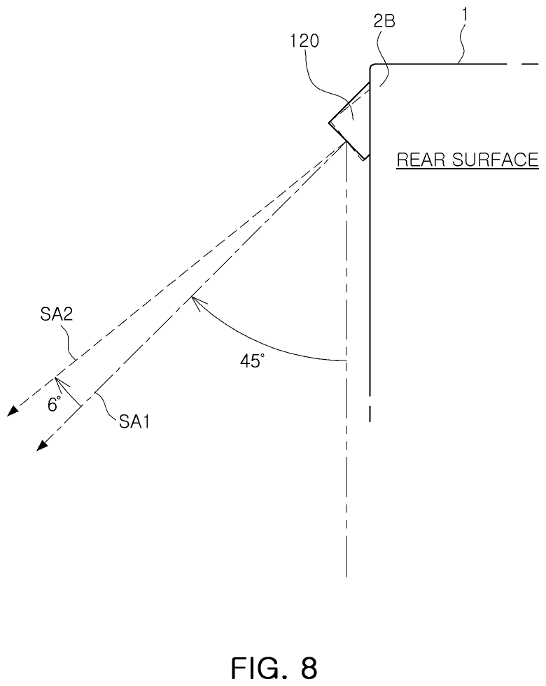

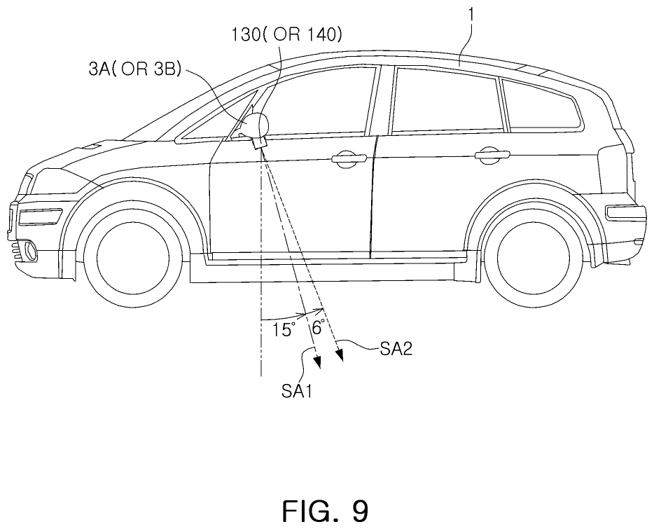

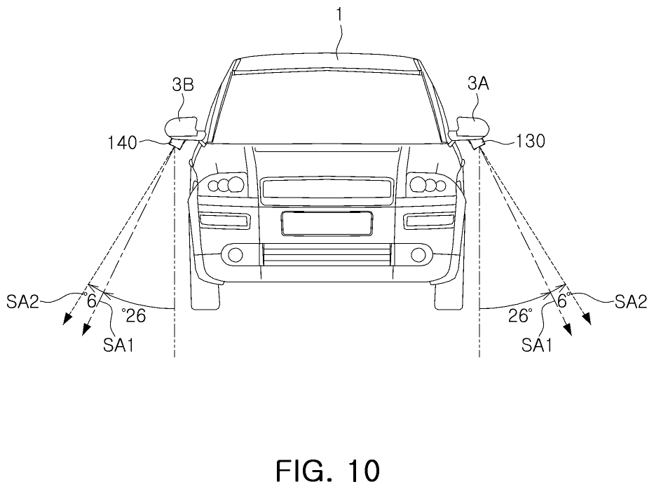

FIG. 7 is a diagram of a parking mode detection angle and a driving mode detection angle of the first camera module 110, according to an embodiment. FIG. 8 is a diagram of a parking mode detection angle and a driving mode detection angle of the second camera module 120, according to an embodiment. FIG. 9 is a diagram of a parking mode detection angle and a driving mode detection angle of the third or fourth camera module 130 or 140, according to an embodiment. FIG. 10 is a diagram of parking mode detection angles and driving mode detection angles of third and fourth camera modules 130 and 140, according to an embodiment.

Referring to FIG. 7, when the first camera module 110 is installed on a front surface 2A of a vehicle 1, in a parking mode, a detection angle SA1 may be 33 degrees forward (33°) with respect to a vertical direction to a ground, and, in the driving mode, a detection angle SA2 may be 39 degrees (39°) forward with respect to the vertical direction to the ground, which is further tilted by 6 degrees (6°) forward of the vehicle than the detection angle in the parking mode.

As described above, the detection angle of the first camera module 110 installed in the front of the vehicle 1 may be increased to 39 degrees in the driving mode, so that detection angle may be adjusted to an optimal angle for a front surface cross traffic alert function.

Referring to FIG. 8, when the second camera module 120 is installed on a rear surface 2B of a vehicle 1, in a parking mode, the detection angle SA1 may be 45 degrees (45°) backward with respect to the vertical direction to the ground, and in a driving mode, a detection angle SA2 may be 51 degrees (51°) backward with respect to the vertical direction to the ground, further tilted by 6 degrees (6°) backward of the vehicle than the detection angle in the parking mode.

As described above, the detection angle of the second camera module 120 installed in the rear may be increased to 51 degrees (51°), so that the detection angle may be adjusted to an optimal angle for a rear surface wide rearview vision function.

Referring to FIG. 9, when the third and fourth camera modules 130 and 140 are installed on a left side 3A and a right side 3B, respectively, of a vehicle 1, in a parking mode, the detection angle SA1 may be 15 degrees (15°) backward, with respect to the vertical direction to the ground, and in a driving mode, the detection angle SA2 may be 21 degrees (21°) backward with respect to the vertical direction to the ground, which is further tilted by 6 degrees (6°) backward of the vehicle than the detection angle in the parking mode.

As described above, the detection angles of the third and fourth camera modules 130 and 140 installed on the left and right sides are increased to the rear by 21 degrees (21°), so that the detection angle may be adjusted to an optimal angle for side surface blind spot detection.

Referring to FIG. 10, when the third and fourth camera modules 130 and 140 are installed on a left side 3A and a rear side 3B, respectively, of a vehicle 1, in a parking mode, a detection angle SA1 may be 26 degrees (26°) laterally outward with respect to the vertical direction to the ground, and in a driving mode, the detection angle SA2 may be 32 degrees (32°) laterally outward with respect to the vertical direction to the ground, which is further tilted by 6 degrees (6°) laterally outward of the vehicle 1 than the detection angle in the parking mode.

As described above, the detection angles of the third and fourth camera modules 130 and 140 installed on the left and right sides are increased to 32 degrees laterally outward, so that the detection angles can be adjusted to an optimum angle for lane change assist.

For example, the vehicle SVM system disclosed herein is an ADAS (advanced driver assistant system), which is one of systems performing a driver's driving assistance function. The ADAS is implemented to provide safer parking by giving the driver parking assistance and warning about an approach of nearby objects when stopping/driving at a low-speed by integrating and displaying images of the cameras in the four directions (front, rear, left, and right).

In order to compensate for a disadvantage that there is a large limitation in the driving mode because only a short-distance information image such as a lane next to the driving lane of the vehicle is acquired and used, in the SVM system using the tilt camera disclosed herein, a central point of a field of view is physically changed according to driving conditions, and, at the same time, a detection region may be varied according to the operating mode of the function of the sensing camera using a hardware method or a software method.

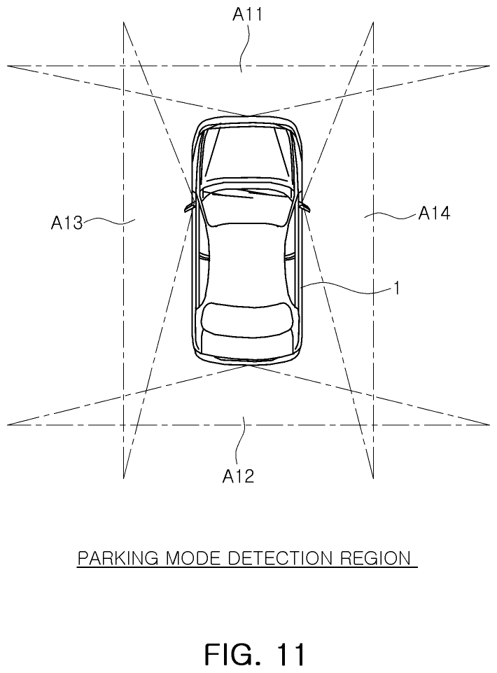

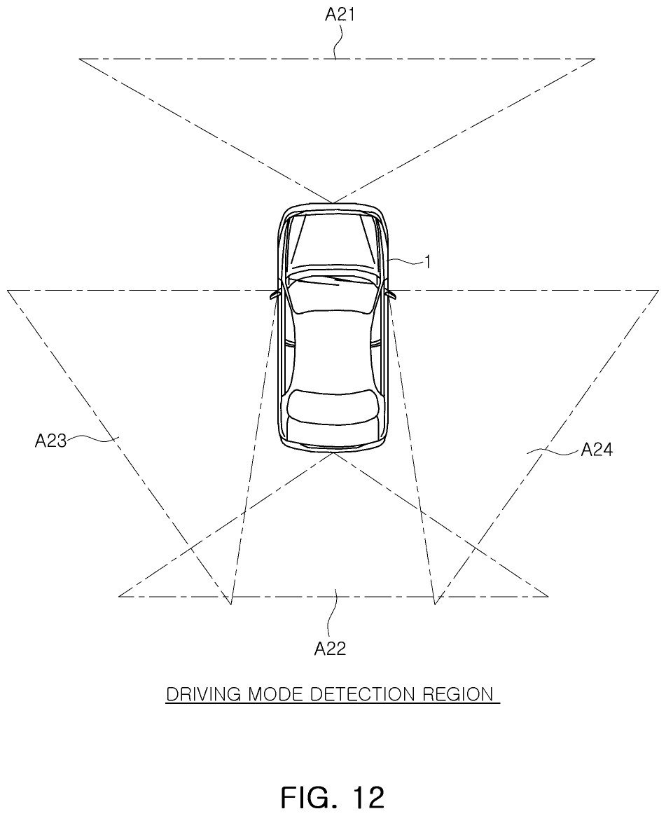

Accordingly, the operating mode of the vehicle is divided into two stages (a parking mode and a driving mode), and regions covered by the vehicle are as follows in the descriptions of FIGS. 11 and 12.

FIG. 11 is a diagram of a parking mode detection region of a vehicle SVM system, according to an embodiment. FIG. 12 is a diagram of a driving mode detection region of the vehicle SVM system, according to an embodiment.

Referring to FIG. 11, in a parking mode of the vehicle SVM system, detection regions may include a front region A11 detected by the first camera module, a rear region A12 detected by the second camera module, and side regions A13 and A14 detected by the second and third camera modules.

Referring to FIG. 12, in a driving mode of the vehicle's SVM system, detection regions may include a front region A21 detected by the first camera module, a rear region A22 detected by the second camera module, and side regions A23 and A24 detected by the second and third camera modules.

The control device 200 of the vehicle SVM system according to an embodiment disclosed herein may be implemented in a computing environment in which a processor (e.g., a central processing unit (CPU), a graphics processor (GPU), a microprocessor, an application specific integrated circuit (ASIC), a field programmable gate array (FPGA)), a memory (a volatile memory (e.g., a RAM), a non-volatile memory (e.g., a ROM and a flash memory), an input device (e.g., a keyboard, a mouse, a pen, a voice input device, a touch input device, an infrared camera, a video input device, or the like), an output device (e.g., a display, a speaker, a printer, or the like), and a communications connection device (e.g., a modem, a network interface card (NIC), an integrated network interface, a wireless frequency transmitter/receiver, an infrared port, a USB connection device, or the like) are interconnected (e.g., peripheral component interconnect (PCI), USB, firmware (IEEE 1394), an optical bus structure, a network, or the like).

The computing environment may be implemented as a personal computer, a server computer, a handheld or laptop device, a mobile device (a mobile phone, a PDA, a media player, or the like), a multiprocessor system, a consumer electronic device, a mini-computer, a mainframe computer, and a distributed computing environment including an above-described random system or device, but an embodiment thereof is not limited thereto.

As set forth above, according to an embodiment disclosed herein, a field of view suitable for a driving mode and a main angle of view using a camera tilt function when parking or driving may be provided by employing a tilt camera having a tilt function in a surround viewing monitor (SVM).

In particular, by adjusting a detection angle (or a detection direction) of the camera according to an operating mode such as a driving mode, a parking mode, or the like, an image suitable for the driving mode may be provided to the driver, and driver convenience can be increased by improving SVM performance, by automatically adjusting the detection angle of the camera to be suitable for driving or parking.

In addition, since the vehicle SVM system can be used for a viewing function in a parking mode, and can be used for a sensing function by titling a center point of a camera angle of view in a high-speed driving mode, the vehicle SVM system can replace a function of a separate sensing camera. Accordingly, cost reduction and performance optimization of the vehicle can be achieved.

The control device 200, the operating mode recognition unit 200, the control signal generation unit 220, the interface unit 300, and the display unit 400 in FIGS. 1-12 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-12 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A vehicle surround viewing monitor (SVM) system, comprising:
a tilt camera device including camera modules configured to image a surround view of a vehicle; and
a control device configured to generate a control signal for adjusting a detection angle of the tilt camera device according to an operating mode of the vehicle, based on received vehicle information,
wherein the tilt camera device is configured to adjust a detection angle of each of the camera modules, in response to the control signal.

2. The vehicle SVM system of claim 1, wherein, in a parking mode, the tilt camera device is configured to adjust the detection angle of each of the camera modules to a predetermined detection angle for parking, based on the control signal, and
wherein, in a driving mode, the tilt camera device is further configured to adjust the detection angle of each of the camera modules to a detection angle for driving that is increased by a preset angle from the predetermined detection angle for parking, based on the control signal.

3. The vehicle SVM system of claim 1, wherein the control device comprises:
an operating mode recognition unit configured to recognize the operating mode of the vehicle as either one of a driving mode and a parking mode, based on vehicle speed information and gear information included in the vehicle information; and
a control signal generation unit configured to generate the control signal to adjust the detection angle of the tilt camera device to a detection angle corresponding to the recognized operating mode.

4. The vehicle SVM system of claim 3, wherein the control device is further configured to generate either one of a driving mode control signal and a parking mode control signal as the detection angle control signal, to control the tilt camera device, to adjust the detection angle of the tilt camera device.

5. The vehicle SVM system of claim 3, wherein the control device is further configured to compensate for the detection angle of the tilt camera device in the recognized operating mode, based on steering angle information included in the vehicle information, and generate the control signal for controlling one or more of the camera modules with the compensated detection angle.

6. The vehicle's SVM system of claim 1, wherein each of the camera modules comprises a voice coil motor actuator configured to adjust the detection angle of the corresponding camera module in response to the control signal.

7. The vehicle SVM system of claim 1, wherein each of the camera modules comprises:
an outer case;
driving coil units disposed on the outer case, and configured to generate electromagnetic force;
a lens unit configured to receive a video image in a corresponding imaging direction for a surround view of the vehicle;
a sensor substrate unit including an image sensor configured to sense a video image through the lens unit, and disposed to be movable through a ball with respect to the outer case; and
driving conductor units disposed on the sensor substrate unit, and configured to be moved by the electromagnetic force generated by a corresponding driving coil unit among the driving coil units, to adjust a detection angle of the lens unit.

8. The vehicle SVM system of claim 1, further comprising:
an interface unit configured to receive the vehicle information and output the vehicle information to the control device; and
a display unit configured to output at least one of images acquired by the tilt camera device, according to the control device, to a screen.

9. A vehicle surround viewing monitor (SVM) system, comprising:
a tilt camera device including a first camera module, a second camera module, a third camera module, and a fourth camera module that are configured to image a surround view of a vehicle;
an interface unit configured to receive vehicle information including vehicle speed information and gear information; and
a control device configured to generate a control signal for adjusting an imaging direction of the tilt camera device according to an operating mode of the vehicle, based on the vehicle information,
wherein the tilt camera device is configured to adjust a detection angle of each of the camera modules, in response to the control signal.

10. The vehicle SVM system of claim 9, wherein, in a parking mode, the tilt camera device is configured to adjust a detection angle of each of the first, second, third, and fourth camera modules to a predetermined detection angle for parking, based on the control signal, and
wherein, in a driving mode, the tilt camera device is further configured to adjust a detection angle of each of the first, second, third, and fourth camera modules to a detection angle for driving that is increased by a preset angle from the detection angle for parking, based on the control signal.

11. The vehicle SVM system of claim 9, wherein the control device comprises:
an operating mode recognition unit configured to recognize the operating mode of the vehicle as either one of a driving mode and a parking mode, based on vehicle speed information and gear information included in the vehicle information; and
a control signal generation unit configured to generate the control signal to adjust the detection angle of the tilt camera device to a detection angle corresponding to the recognized operating mode.

12. The vehicle SVM system of claim 11, wherein the control device is further configured to generate either one of a driving mode control signal and a parking mode control signal to control the tilt camera device, to adjust the detection angle of the tilt camera device.

13. The vehicle SVM system of claim 9, wherein the control device is further configured to compensate for the detection angle of the tilt camera device in the recognized corresponding operating mode, based on steering angle information included in the vehicle information, and generate the control signal for controlling one or more of the camera modules with the compensated detection angle.

14. The vehicle SVM system of claim 9, wherein each of the camera modules comprises a voice coil motor actuator configured to adjust the detection angle of the corresponding camera module in response to the control signal.

15. The vehicle SVM system of claim 9, wherein each of the first, second, third, and fourth camera modules comprises:
an outer case;
driving coil units disposed on the outer case, and configured to generate electromagnetic force;
a lens unit configured to receive a video image in a corresponding imaging direction for a surround view of the vehicle;
a sensor substrate unit including an image sensor configured to sense a video image through the lens unit, and disposed to be movable through a ball with respect to the outer case; and
driving conductor units disposed on the sensor substrate unit, and configured to be moved by the electromagnetic force generated by a corresponding driving coil unit among the driving coil units, to adjust a detection angle of the lens unit.

16. The vehicle SVM system of claim 9, further comprising a display unit configured to output at least one of images acquired by the tilt camera device, according to the control device, to a screen.

17. A method of providing a surround view of a vehicle, the method comprising:
recognizing an operating mode of the vehicle based on received vehicle information;
generating a control signal for a tilt camera device of the vehicle, according to the recognized operating mode; and
adjusting a detection angle of each of camera modules of the tilt camera device, in response to the control signal, wherein the camera modules are configured to image a surround view of a vehicle.

18. The method of claim 17, wherein the recognizing of the operating mode comprises:
recognizing the operating mode as a parking mode, in response to the vehicle being driven at a speed less than a threshold speed or being driven in reverse; or
recognizing the operating mode as a driving mode, in response to the vehicle being driven at a speed greater than the threshold speed.

19. The method of claim 17, wherein the adjusting of the detection angle of each of the camera modules comprises adjusting the detection angle of each of the camera modules to a respective preset detection angle corresponding to the control signal.

20. The method of claim 19, wherein the camera modules comprise:
a front camera module disposed at a front side of a vehicle;
a rear camera module disposed at a rear side of the vehicle; and
side camera modules respectively disposed at a left and right sides of the vehicle.

21. A non-transitory computer-readable storage medium storing instructions that, when executed by a processor, cause the processor to perform the method of claim 17.
